(19) United States
(12) Patent Application Publication
(10) Pub. No.: US 2022/0122125 A1
(43) Pub. Date: Apr. 21, 2022

(54) INFORMATION PROCESSING DEVICE, INFORMATION PROCESSING SYSTEM, DISPLAY CONTROL METHOD, AND RECORDING MEDIUM

(71) Applicant: NEC Corporation, Minato-ku, Tokyo (JP)

(72) Inventor: Jun UCHIMURA, Tokyo (JP)

(73) Assignee: NEC Corporaton, Minato-ku, Tokyo (JP)

(21) Appl. No.: 17/422,404

(22) PCT Filed: Feb. 26, 2020
(86) PCT No.: PCT/JP2020/007570

§ 371 Date: Jul. 12, 2021

(30) Foreign Application Priority Data
Mar. 20, 2019 (JP) 2019-053722

(51) Int. Cl. G06Q 30/02; G06V 40/16; G09G 3/26

(52) U.S. Cl. CPC G06Q 30/0255; G09G 3/26; G06V 40/173; G06Q 30/0261

(57) ABSTRACT

An information processing device 400 is configured to be provided with a detection unit 410 and a control unit 420 so that an advertisement can be outputted to a customer at an appropriate timing. The detection unit 410 detects the position of a customer that has come to a store. The display control unit 420 causes a display device associated with a predetermined position in the store to display an advertisement when the distance between the detected position of the customer and the predetermined position is a predetermined value or less.

### TECHNICAL FIELD

The present disclosure relates to an information processing device, an information processing system, a display control method, and a recording medium on which a program is recorded.

### BACKGROUND ART

In recent years, a technique using, as an advertisement medium, a digital signage (electronic billboard) arranged in a variety of places such as outdoors, storefronts, public spaces, and transportation facilities has been provided.

For example, PTL 1 discloses a secure and safe digital signage device having favorable customer acceptability by utilizing a face recognition processing function. This digital signage device acquires pictures of surrounding passersby and customers using a camera to perform image processing on the acquired pictures, and acquires face attributes and detection environment attributes to accumulate the acquired face attributes and detection environment attributes. Then, the digital signage device identifies between the background and a person or identifies identical persons on the basis of the accumulated history information, and controls a target device.

### CITATION LIST

### Patent Literature

[PTL 1] JP 2013-003817 A

### SUMMARY OF INVENTION

### Technical Problem

In PTL 1 mentioned above, a customer is imaged by the camera, and content to be displayed on a digital signage is selected and displayed based on an estimated age and an estimated gender obtained from the acquired imaged data. However, if the timing of outputting an advertisement to the customer is not appropriate, there is a problem that the appeal effect of the advertisement is reduced.

An object of the present disclosure is to solve the above-mentioned problem and to provide an information processing device, an information processing system, a display control method, and a recording medium capable of outputting an advertisement to a customer at an appropriate timing.

### Solution to Problem

An information processing device according to one aspect of the present disclosure includes: a detection unit that detects a position of a customer who has come to a store; and a display control unit that causes a display device associated with a predetermined position in the store to display an advertisement when a distance between the detected position of the customer and the predetermined position is equal to or less than a predetermined value.

An information processing system according to an aspect of the present disclosure includes: a display device installed in a store in association with a predetermined position; and an information processing device, in which the information processing device includes: a detection unit that detects a position of a customer who has come to the store; and a display control unit that causes the display device associated with the predetermined position to display an advertisement when a distance between the detected position of the customer and the predetermined position is equal to or less than a predetermined value.

A display control method according to one aspect of the present disclosure includes: detecting a position of a customer who has come to a store; and causing a display device associated with a predetermined position in the store to display an advertisement when a distance between the detected position of the customer and the predetermined position is equal to or less than a predetermined value.

A recording medium according to one aspect of the present disclosure records a program for causing a computer to execute: processing of detecting a position of a customer who has come to a store; and processing of causing a display device associated with a predetermined position in the store to display an advertisement when a distance between the detected position of the customer and the predetermined position is equal to or less than a predetermined value.

### Advantageous Effects of Invention

An effect of the present disclosure is that an advertisement can be outputted to a customer at an appropriate timing.

### BRIEF DESCRIPTION OF DRAWINGS

FIG. 1 is a block diagram illustrating a configuration of an information processing system according to a first example embodiment.

FIG. 2 is a diagram schematically illustrating an example of the inside of a store in which advertisement display is performed by the information processing system according to the first example embodiment.

FIG. 3 is a flowchart explaining an operation of the information processing system according to the first example embodiment.

FIG. 4 is a diagram illustrating an example of map information.

FIG. 5 is a diagram schematically illustrating another example of the inside of a store in which advertisement display is performed by the information processing system according to the first example embodiment.

FIG. 6 is a diagram schematically illustrating the inside of a store in which a plurality of digital signages is installed.

FIG. 7 is a block diagram illustrating a configuration of an information processing system according to a third example embodiment.

FIG. 8 is a flowchart explaining an operation of the information processing system according to the third example embodiment.

FIG. 9A is a diagram explaining the determination of the orientation of the face of a customer by a determination unit of the information processing system according to the third example embodiment.

FIG. 9B is a diagram explaining the determination of the orientation of the face of a customer by a determination unit of the information processing system according to the third example embodiment.

FIG. 10 is a block diagram illustrating a configuration of an information processing system according to a fourth example embodiment.

FIG. 11 is a diagram illustrating an example of purchase history information.

FIG. 12 is a flowchart explaining an operation of the information processing system according to the fourth example embodiment.

FIG. 13 is a flowchart explaining an operation of an information processing system according to a fifth example embodiment.

FIG. 14 is a flowchart explaining an operation of an information processing system according to a sixth example embodiment.

FIG. 15 is a block diagram illustrating a configuration of an information processing device according to a seventh example embodiment.

FIG. 16 is a diagram illustrating an example of the hardware configuration of the information processing device according to each example embodiment.

### EXAMPLE EMBODIMENT

Example embodiments will be described in detail with reference to the drawings. In the respective drawings and the respective example embodiments described in the description, the same reference signs are given to similar constituent elements, and the description thereof will be omitted as appropriate.

### First Example Embodiment

A first example embodiment will be described.

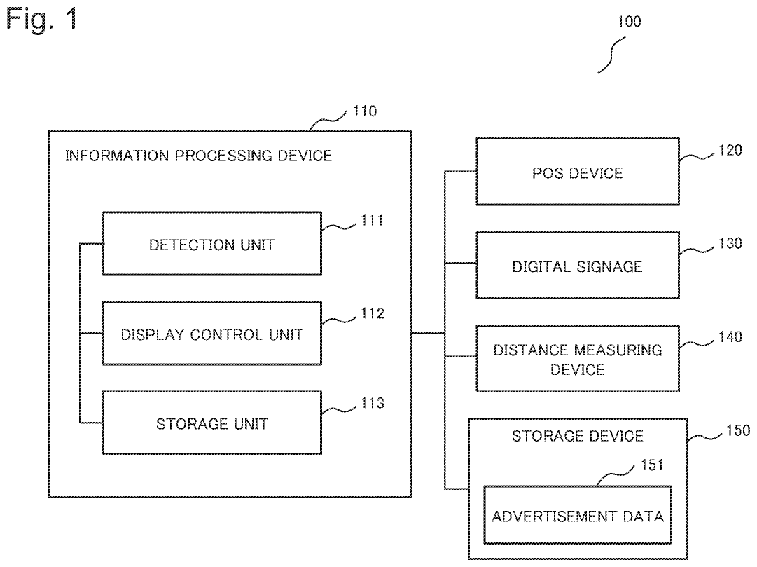

FIG. 1 is a block diagram illustrating a configuration of an information processing system 100 according to the first example embodiment. As illustrated in FIG. 1, the information processing system 100 includes an information processing device 110, a point-of-sales (POS) device 120, a digital signage 130, a distance measuring device 140, and a storage device 150.

The POS device 120, the digital signage 130, and the distance measuring device 140 are installed in a store in a retail business, such as a convenience store or a supermarket, for example.

The information processing device 110 is, for example, a computer, and performs processing such as control of each device such as the POS device 120, the digital signage 130, the distance measuring device 140, and the storage device 150, acquisition of information from each device, and analysis of the acquired information.

The POS device 120 performs product registration, settlement of payment, and the like at the time of selling a product or the like in the store.

The digital signage 130 is a device that displays advertisement content such as pictures and characters by a display, a projector, or the like. The digital signage 130 includes a display device such as a liquid crystal display, an organic light emitting diode (OLED) display, or a light emitting diode (LED) display. The advertisement content displayed on the digital signage 130 may be a moving image or a still image. The digital signage 130 acquires advertisement data 151 from the storage device 150, based on an instruction from the information processing device 110, and outputs the acquired advertisement data to a display or the like. The digital signage 130 may also acquire the advertisement data 151 from the storage device 150 in advance to store the acquired advertisement data 151 in an internal storage device, and output the acquired advertisement data 151 to a display or the like, based on an instruction from the information processing device 110. The digital signage 130 only needs to be a device provided with at least an output device, an input device, and a function capable of communicating with the information processing device 110, and is not limited to the digital signage. The digital signage 130 may be configured integrally with the information processing device 110.

The installation location of the digital signage 130 is not particularly limited. For example, the digital signage 130 may be installed in the vicinity of a doorway of a store, may be installed on a product shelf, a door of a product shelf, a window of the store, a ceiling, or the like, or may be installed on a floor of the store.

The distance measuring device 140 is a device such as a stereo camera device or a light detection and ranging (LiDAR) device, and can acquire a spatial distribution of a distance from the distance measuring device 140 to a distance measurement target. The distance measuring device 140 notifies the information processing device 110 of the acquired distance information.

The storage device 150 stores the advertisement data 151 regarding advertisements, publicity, events, and the like to be displayed on the digital signage 130. The storage device 150 may be installed in the store, or may be arranged in a place different from the store to be connected to the information processing device 110 via a communication network. The storage device 150 may be configured integrally with at least one of the information processing device 110 and the digital signage 130.

Next, the configuration and operation of the information processing device 110 will be described.

As illustrated in FIG. 1, the information processing device 110 includes a detection unit 111, a display control unit 112, and a storage unit 113.

The detection unit 111 detects the position of a customer in the store, based on the distance information obtained by the distance measuring device 140. The detection unit 111 corresponds to a detection means for detecting the position of a customer who has come to a store.

When a distance between the position of the customer detected by the detection unit 111 and the position of the digital signage 130 is equal to or less than a predetermined value, the display control unit 112 causes the digital signage 130 to display an advertisement. The display control unit 112 corresponds to a display control means for causing a display device associated with a predetermined position in the store to display an advertisement when a distance between the detected position of the customer and the predetermined position is equal to or less than a predetermined value.

The storage unit 113 stores the distance information obtained by the distance measuring device 140.

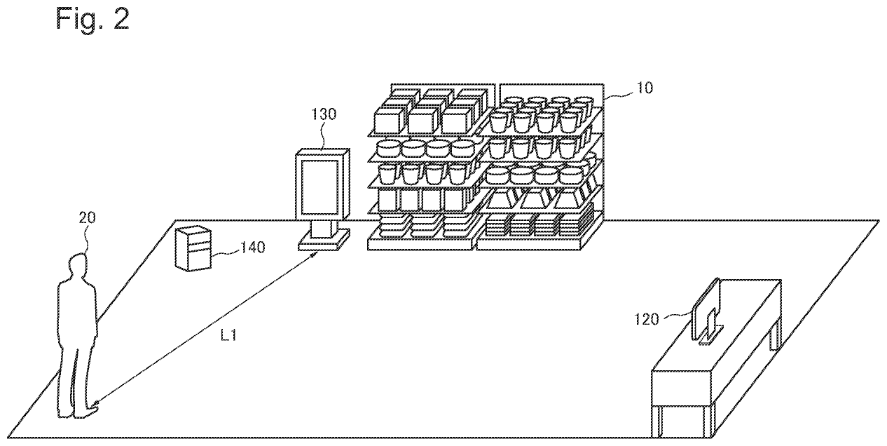

FIG. 2 is a diagram schematically illustrating an example of the inside of a store in which advertisement display is performed by the information processing system 100 according to the first example embodiment. As illustrated in FIG. 2, for example, it is assumed that the digital signage 130 and the distance measuring device 140 are installed in the vicinity of a product shelf 10 of the store, and a customer 20 has come to the store.

The distance measuring device 140 performs distance measurement within a predetermined distance measurement range including the customer 20 located in the vicinity of the digital signage 130. This distance measurement may be, for example, three-dimensional measurement in which a distance in a depth direction is measured while scanning is performed in two directions of a vertical direction and a horizontal direction. In this case, three-dimensional information within a range including the vicinity of the digital signage 130 can be obtained. In a case where the distance measuring device 140 is a LiDAR device, the distance measuring accuracy in the depth direction can be improved as compared with a case where a stereo camera or the like is adopted.

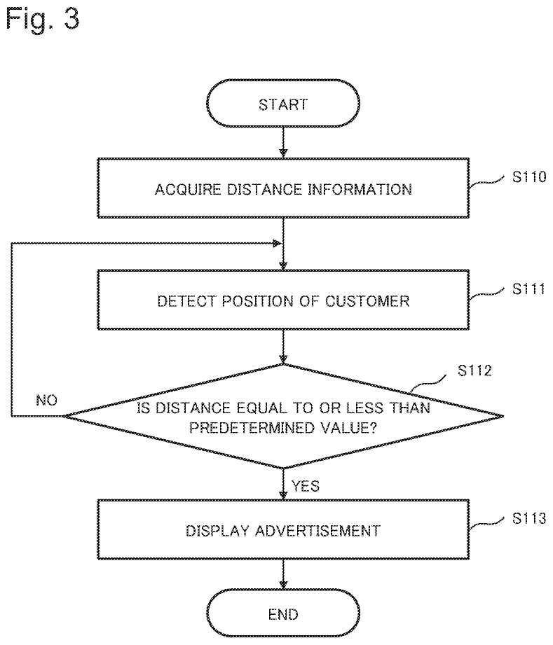

FIG. 3 is a flowchart explaining an operation of the information processing system 100. An operation of the information processing system 100 will be described with reference to FIG. 3.

The information processing device 110 instructs the distance measuring device 140 to perform distance measurement within a range including the vicinity of the digital signage 130. A timing at which the distance measurement instruction is given to the distance measuring device 140 can be a timing at which it is detected that the customer 20 has come to the store. In order to detect that the customer 20 has come to the store, the inside of the store may be constantly imaged by a camera installed in the store in such a way that the customer 20 is detected from the acquired imaged data. Alternatively, a human sensor or the like installed in the store may be employed for sensing. The distance measuring device 140 may also constantly monitor the periphery of the digital signage 130. In this case, the distance information is constantly transmitted to the information processing device 110 by the distance measuring device 140. In the present example embodiment, it is supposed that the information processing device 110 instructs the distance measuring device 140 to perform distance measurement.

The distance measuring device 140 performs distance measurement in response to the above instruction. The distance information acquired by this distance measurement is transmitted to the information processing device 110 and stored in the storage unit 113 (step S110).

The detection unit 111 detects the position of the customer 20 based on the distance information obtained by the distance measuring device 140 (step S111). For example, in this detection, all customers located within a predetermined range may be detected, or one customer present in the vicinity of the digital signage 130 may be detected. In the present first example embodiment, it is supposed that one customer has been detected.

The detection unit 111 may detect the position of the customer as coordinate values with respect to map information that defines a coordinate system for the store. The map information indicates coordinates of each position in the store in accordance with, for example, an orthogonal coordinate system having a predetermined position in the store as an origin. The map information may define a two-dimensional orthogonal coordinate system in which one side is defined as an x-axis and the other side is defined as a y-axis for a store having a rectangular floor, for example.

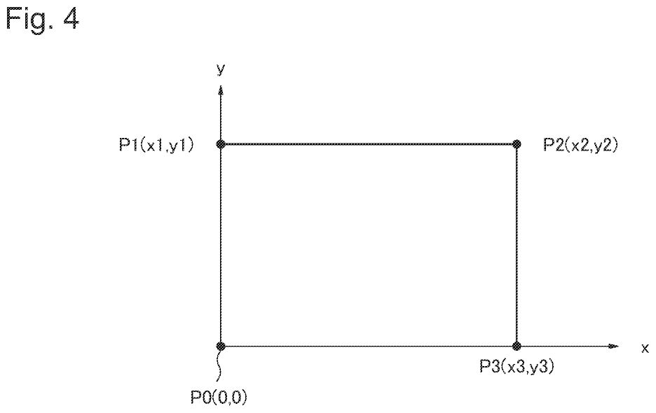

FIG. 4 is a diagram illustrating an example of the map information.

For example, the map information represents the two-dimensional structure of the store by coordinate information indicating P0=(0, 0), P1=(x1, y1), P2=(x2, y2), and P3=(x3, y3) in the figure. The position of the customer can be represented by an x coordinate value and a y coordinate value of this orthogonal coordinate system. The map information may be stored in the storage unit 113.

The display control unit 112 calculates a distance (indicated by “L1” in FIG. 2) between the position of the customer 20 detected by the detection unit 111 and the position of the digital signage 130. Here, the digital signage 130 is installed in association with a predetermined position in the store. Therefore, the display control unit 112 calculates the distance L1 between the detected position of the customer 20 and the predetermined position.

The predetermined position associated with (the installation of) the digital signage 130 may be, for example, included in advance as coordinate values in the map information exemplified in FIG. 4 and stored in the storage unit 113. The detection unit 111 may calculate the distance L1 between the position of the customer and the predetermined position based on coordinate values of each of the position of the customer and the predetermined position. Any place in the store may be chosen to correspond to the predetermined position.

When the calculated distance L1 is equal to or less than a predetermined value (Yes in step S112), the display control unit 112 causes the digital signage 130 to display an advertisement (step S113). That is, the display control unit 112 instructs the digital signage 130 to display the advertisement, and the digital signage 130 displays the advertisement on a display based on the advertisement data stored in the storage device 150 in response to the above instruction. The contents of the advertisement to be displayed can be optional. The digital signage 130 may acquire the advertisement data 151 from the storage device 150 in advance to store the acquired advertisement data 151 in an internal storage device, and output the acquired advertisement data 151 to a display or the like, based on the instruction from the information processing device 110.

Here, it is only required to set any value in advance for the predetermined value. For example, the predetermined value can be set according to the area of the store, the size of the display of the digital signage 130, the installation status of the digital signage 130 in the store, and the like.

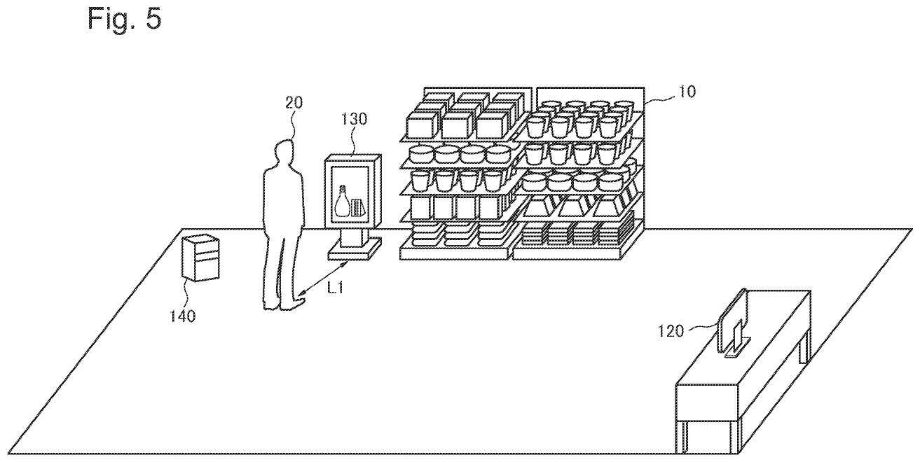

FIG. 5 is a diagram schematically illustrating another example of the inside of a store in which advertisement display is performed by the information processing system 100. It is supposed that the distance L1 between the position of the customer 20 and the position of the digital signage 130 has become equal to or less than the predetermined value because of the movement of the customer 20. In this case, an advertisement is displayed on the digital signage 130 by the display control unit 112.

As described above, according to the present first example embodiment, the detection unit 111 of the information processing device 110 detects the position of the customer in the store, and the display control unit 112 causes the digital signage 130 to display an advertisement when a distance between the position of the customer and the position of the digital signage 130 is equal to or less than a predetermined value. By adopting this configuration, according to the present first example embodiment, it is possible to obtain an effect that an advertisement can be displayed at an appropriate timing when a customer has approached the digital signage 130 within a predetermined distance.

### Second Example Embodiment

A second example embodiment will be described.

In the second example embodiment, an example in which the information processing system 100 described in the first example embodiment includes a plurality of digital signages 130 will be described. That is, in an information processing system according to the second example embodiment, a case where a plurality of digital signages 130 is connected to an information processing device 110 in such a way that communication is enabled, and each of this plurality of digital signages 130 is installed at a predetermined position in a store will be described.

The second example embodiment is similar to the first example embodiment except a configuration in which the information processing system includes the plurality of digital signages 130. In the second example embodiment, a configuration different from the configuration of the first example embodiment will be described.

In the present example embodiment, the predetermined position associated with each digital signage 130 is stored in advance in a storage unit 113. According to the layout and height of the product shelves and various sorts of equipment in the store, one or a plurality of distance measuring devices 140 may be installed in such a way that the distance information can be acquired by the distance measuring device 140 regardless of which place the customer is located at in the store.

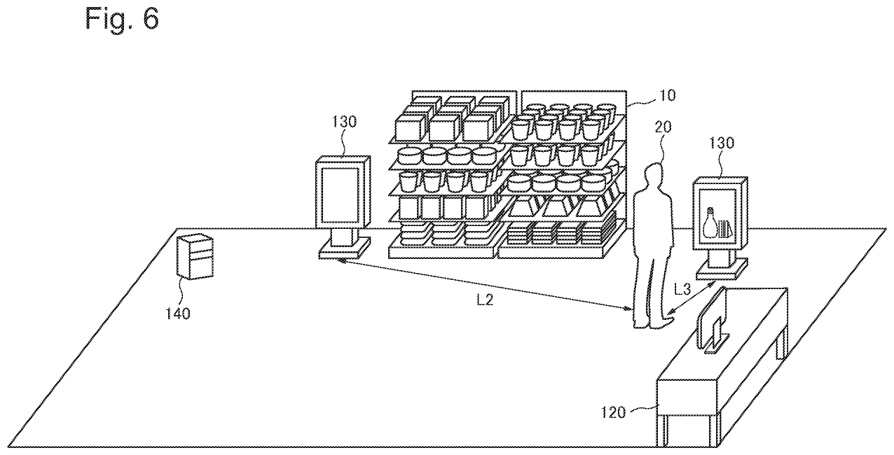

FIG. 6 is a diagram schematically illustrating the inside of a store in which a plurality of digital signages 130 is installed. As illustrated in FIG. 6, in a case where a plurality of digital signage 130 is installed, the display control unit 112 calculates an individual distance (indicated by “L2” and “L3” in FIG. 6) between the position of a customer detected by a detection unit 111 and the position of each digital signage 130.

A display control unit 112 causes a digital signage 130 associated with a position among the plurality of predetermined positions, at which a distance from the position of the customer is smaller than those of the other digital signages and the distance is equal to or less than a predetermined value, to display an advertisement. In other words, the display control unit 112 causes a digital signage 130 closest to the customer among the plurality of digital signages 130 to display the advertisement.

As described above, in the information processing system according to the present second example embodiment, since the advertisement is displayed on a digital signage 130 closest to the customer among the plurality of digital signages 130 by the display control unit 112, a digital signage 130 closest to the customer can be caused to display an advertisement even if the customer moves. Therefore, according to the second example embodiment, a customer can be made to recognize the advertisement as an advertisement exclusively for the customer, and the appeal effect of the advertisement can be further enhanced.

The display control unit 112 may hold a second predetermined value in advance in such a way as to stop displaying the advertisement displayed on the digital signage 130 when a distance between the position of the customer and the position of the digital signage 130 becomes equal to or more than the second predetermined value. The display of the advertisement may be stopped when another customer approaches the digital signage 130 within a predetermined distance.

### Third Example Embodiment

A third example embodiment will be described. Reference signs that match the reference signs given in the drawings of the first example embodiment denote the same functional components, and redundant description of such functional components will be omitted.

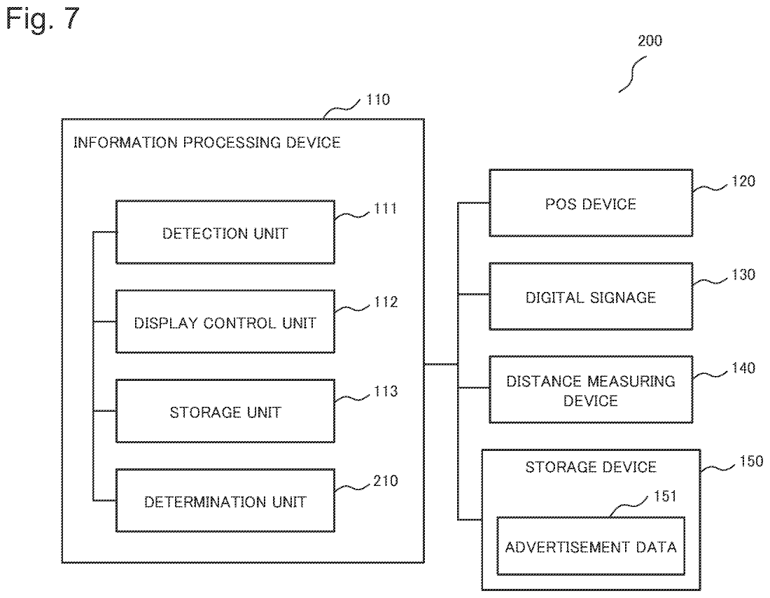

FIG. 7 is a block diagram illustrating a configuration of an information processing system 200 according to the third example embodiment. An information processing device 110 of the information processing system 200 according to the third example embodiment includes a determination unit 210 in addition to the configuration of the information processing device 110 described in the first example embodiment.

The determination unit 210 detects the orientation of the face of the customer based on the distance information obtained by a distance measuring device 140, and determines whether the face of the customer is facing a digital signage 130. The determination unit 210 corresponds to a determination means for determining whether the orientation of the face of the customer is facing the display device.

For example, the determination unit 210 determines that the face of the customer faces the display device when a distance L between the digital signage 130 and the customer is equal to or less than a predetermined value and is decreasing in the distance information obtained by a plurality of distance measurements. The determination unit 210 may also determine whether the orientation of the face of the customer is facing the display device, on the basis of the amount of change in the distance L between the digital signage 130 and the customer. For example, when the amount of change in the distance L becomes smaller while the distance L between the digital signage 130 and the customer is equal to or less than a predetermined value and is decreasing, it may be determined that the face of the customer faces the display device.

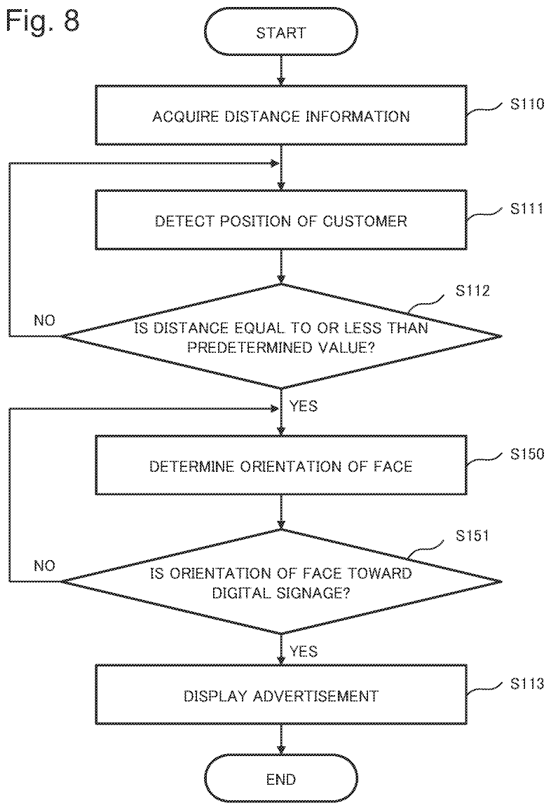

FIG. 8 is a flowchart explaining an operation of the information processing system 200 according to the third example embodiment. An operation of the information processing system 200 will be described with reference to FIG. 8.

As in the first example embodiment, a detection unit 111 detects the position of a customer 20 based on the distance information obtained by the distance measuring device 140 (step S111). A display control unit 112 calculates a distance between the position of the customer 20 detected by the detection unit 111 and the position of the digital signage 130.

When the calculated distance L is equal to or less than the predetermined value (Yes in step S112), the display control unit 112 instructs the determination unit 210 to determine the orientation of the face of the customer. The determination unit 210 detects the orientation of the face of the customer 20 based on the distance information obtained by the distance measuring device 140, and determines whether the face of the customer 20 is facing the digital signage 130 (step S150).

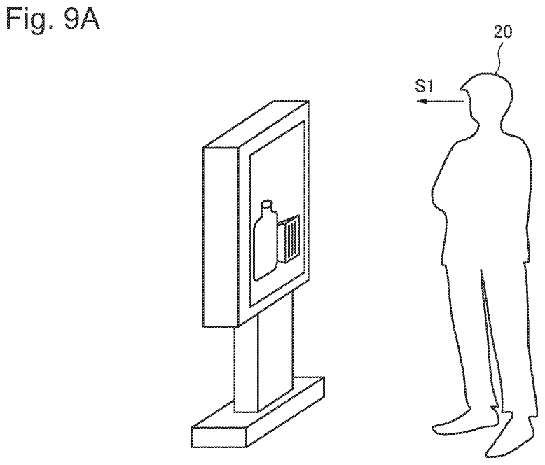

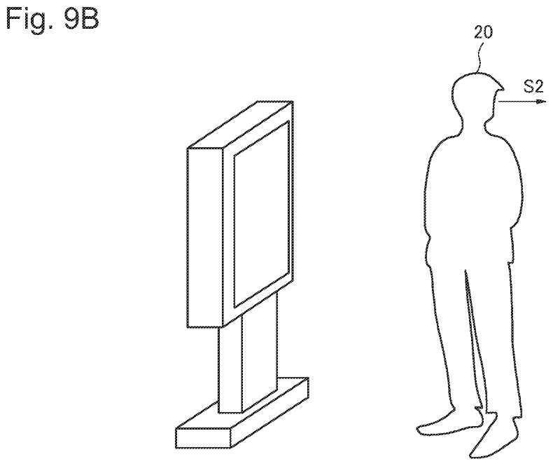

FIGS. 9A and 9B are diagrams explaining the determination of the orientation of the face of the customer by the determination unit 210. FIG. 9A illustrates a case where the orientation of the face of the customer 20 indicated by an arrow 51 is facing the digital signage 130. In FIG. 9A, the distance L between the customer 20 and the digital signage 130 is in a state equal to or less than the predetermined value and decreasing. FIG. 9B illustrates a case where the orientation of the face of the customer 20 indicated by an arrow S2 is not facing the digital signage 130. In FIG. 9B, the distance L between the customer 20 and the digital signage 130 is in a state more than the predetermined value or in a state equal to or less than the predetermined value and increasing. In the case illustrated in FIG. 9A, the determination unit 210 determines that the face of the customer is facing the digital signage 130, and in the case illustrated in FIG. 9B, the determination unit 210 determines that the face of the customer is not facing the digital signage 130.

The determination unit 210 notifies the display control unit 112 of the result of the determination.

The determination unit 210 may determine the orientation of the face of the customer every time the distance information is obtained by the distance measuring device 140, or may determine the orientation of the face of the customer when a distance between the position of the customer and the position of the digital signage 130 is equal to or less than the predetermined value. In the former case, in regard to the determination unit 210, the display control unit 112 may acquire the determination result from the determination unit 210 at a timing when the calculated distance L becomes equal to or less than the predetermined value.

When acquiring the determination result that the face of the customer 20 is facing the digital signage 130 from the determination unit 210 (Yes in step S151), the display control unit 112 causes the digital signage 130 to display an advertisement (step S113).

As described above, according to the present third example embodiment, the determination unit 210 of the information processing device 110 determines whether the face of the customer is facing the digital signage 130, and causes the digital signage 130 to display an advertisement when the face of the customer is facing the digital signage 130. By adopting this configuration, according to the present third example embodiment, it is possible to obtain an effect that the appeal effect of the advertisement to the customer can be further enhanced.

After step S113 in FIG. 8, in a case where the determination unit 210 determines that the face of the customer 20 is not facing the digital signage 130, the display control unit 112 may exercise control to stop displaying the advertisement. At this time, in a case where it is determined that the face of the customer 20 is not facing the digital signage 130 for a predetermined period of time or more, the display control unit 112 may exercise control to stop displaying the advertisement displayed on the digital signage 130.

### Fourth Example Embodiment

A fourth example embodiment will be described. Reference signs that match the reference signs given in the drawings of the first example embodiment denote the same functional components, and redundant description of such functional components will be omitted.

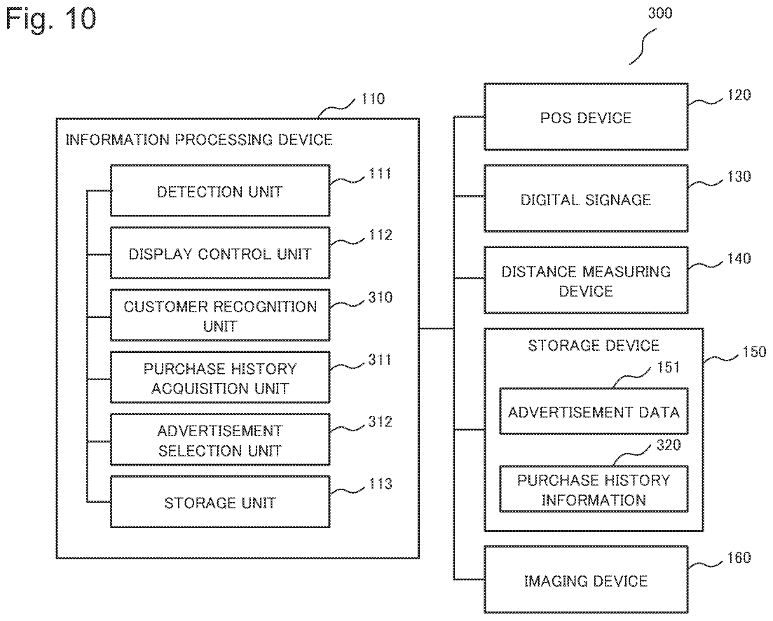

FIG. 10 is a block diagram illustrating a configuration of an information processing system 300 according to the fourth example embodiment. The information processing system 300 further includes an imaging device 160 in addition to the information processing system 100 described in the first example embodiment.

The imaging device 160 is, for example, a camera or a video camera installed in various places such as a cash register counter, a ceiling, and a wall surface of a store. One or a plurality of imaging devices 160 may be installed in such a way that the entire inside of the store can be captured. The imaging device 160 notifies an information processing device 110 of the generated imaged data. The imaged data as a moving image or a still image notified to the information processing device 110 may be stored in a storage unit 113. The imaged data may be stored in a storage device 150.

The information processing device 110 of the information processing system 300 includes a customer recognition unit 310, a purchase history acquisition unit 311, and an advertisement selection unit 312 in addition to the configuration of the information processing device 110 described in the first example embodiment. The storage unit 113 stores a customer identification (ID) in addition to the distance information.

The storage device 150 of information processing system 300 stores purchase history information 320 in addition to advertisement data 151. The purchase history information 320 is information in which a customer who has come to a store is associated with information regarding a product purchased by this customer.

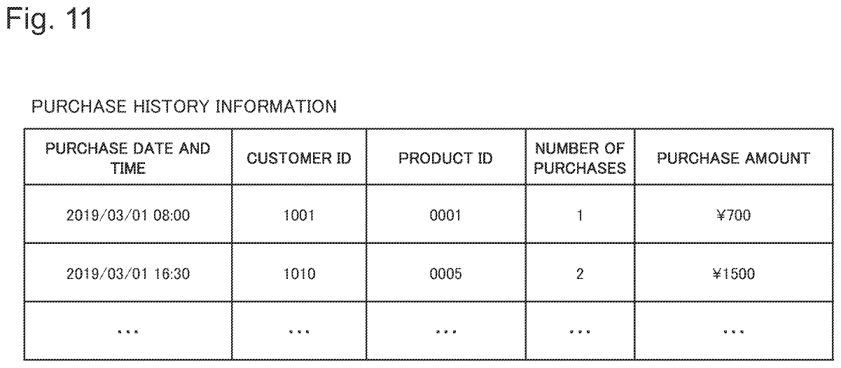

FIG. 11 is a diagram illustrating an example of the purchase history information. As illustrated in FIG. 11, the purchase history information includes, for example, a purchase date and time, a customer ID, a product ID, the number of purchases, and a purchase amount. A POS device 120 illustrated in FIG. 10 may generate the purchase history information as illustrated in FIG. 11 every time a customer who has come to a store purchases a product, and store the generated purchase history information in the storage device 150. The customer ID may be acquired based on the imaged data before purchase, may be acquired by reading various sorts of cards by a card reading device in the store, or may be acquired by acquiring information on a mobile terminal of the customer by a relay device in the store. The purchase history information 320 is not limited to the customer who has visited the store, and may include the purchase history information on a customer who has visited another store.

Next, functional components different from the functional components of the information processing device 110 in the first example embodiment will be described.

The customer recognition unit 310 of the information processing device 110 recognizes a customer in the store. For example, the customer recognition unit 310 recognizes the customer in the store based on the imaged data acquired from the imaging device 160. The customer recognition unit 310 may also recognize the customer in the store based on the result of reading various sorts of cards by the card reading device in the store, the result of acquiring information on the mobile terminal of the customer by the relay device in the store, and the like. The customer recognition unit 310 stores the customer ID obtained by the recognition in the storage unit 113. The customer recognition unit 310 corresponds to a customer recognition means for recognizing a customer.

The purchase history acquisition unit 311 acquires, from the storage device 150, the purchase history information on the customer in the store recognized by the customer recognition unit 310. That is, the purchase history acquisition unit 311 uses the customer ID recognized by the customer recognition unit 310 and stored in the storage unit 113 to acquire the purchase history information associated with the customer ID. The purchase history information may be information indicating a history of all past purchases, or may be information indicating a purchase history in a predetermined past period of time (for example, the past one month or the past one year).

The advertisement selection unit 312 selects an advertisement suitable for a customer based on the purchase history information on the customer acquired by the purchase history acquisition unit 311. For example, the advertisement selection unit 312 may select an advertisement relating to a new product in a case where the purchase frequency of a new product is high, or may select an advertisement relating to a product with a high purchase frequency, or an advertisement relating to a new product of the same brand as a product with a high purchase frequency, or an advertisement relating to a new brand. The advertisement selection unit 312 may also select information on a discount or a coupon as an advertisement. Existing techniques can be used as an approach for selecting an advertisement based on the purchase history information on a customer. The purchase history acquisition unit 311 and the advertisement selection unit 312 correspond to an advertisement selection means for selecting an advertisement based on a purchase history associated with the recognized customer.

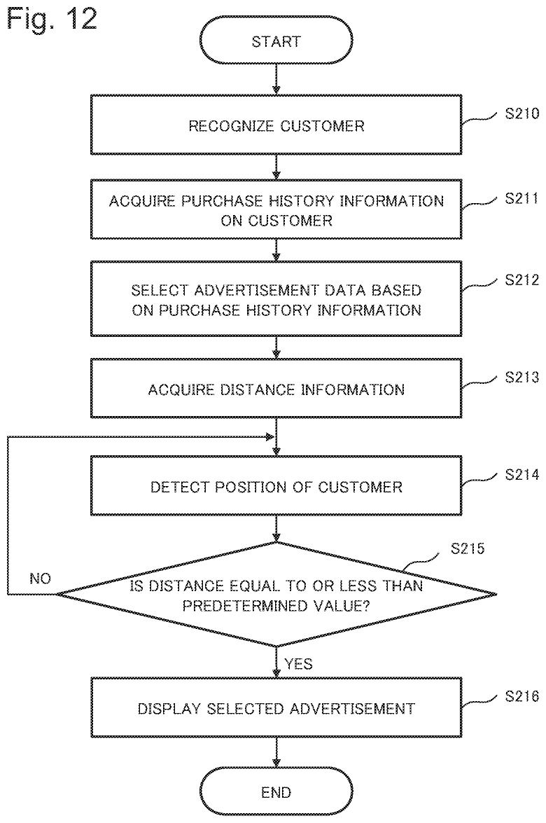

FIG. 12 is a flowchart explaining an operation of the information processing system 300 according to the fourth example embodiment. An operation of the information processing system 300 will be described with reference to FIG. 12.

The customer recognition unit 310 recognizes a customer who has come to the store (S210). For example, the customer recognition unit 310 reads the customer ID stored in a membership card or the like of the store via a card reading device provided at an entrance or the like of the store. The customer recognition unit 310 stores the customer ID read from the card in the storage unit 113. This allows the recognition of the customer in the store. The card is not limited to the membership card, and may be a transportation integrated circuit (IC) card, an employee ID card, a smartphone displaying a two-dimensional barcode, or the like.

The customer recognition unit 310 may also recognize the customer present in the store by analyzing the imaged data of the customer when coming to the store or while moving in the store, which has been acquired from the imaging device 160 and stored in the storage unit 113. At this time, the customer recognition unit 310 may recognize the customer from the image of the customer in the store, using various sorts of existing person specifying algorithms. The customer recognition unit 310 may recognize the customer by, for example, face authentication processing. That is, the customer recognition unit 310 may specify the customer using the imaged data and a database in which the feature amount of the appearance of the customer is registered in advance. Existing techniques can be used for the face authentication processing. The customer recognition unit 310 specifies and acquires the customer ID assigned on a customer basis from the image recognition result. The customer recognition unit 310 stores the acquired customer ID in the storage unit 113.

The purchase history acquisition unit 311 acquires, from the storage device 150, the purchase history information 320 associated with the customer ID stored in the storage unit 113 (step S211).

Based on the acquired purchase history information 320, the advertisement selection unit 312 selects advertisement data suitable for the recognized customer (step S212).

Steps S210 to S212 may be performed when the customer comes to the store or at a timing when the imaged data of the customer moving in the store is acquired.

Steps S213 to S216 are the same processing as steps S110 to S113 in FIG. 3.

That is, the information processing device 110 acquires the distance information from a distance measuring device 140 (step S213). A detection unit 111 detects the position of the customer 20 based on the distance information obtained by the distance measuring device 140 (step S214).

A display control unit 112 calculates the distance L between the position of the customer 20 detected by the detection unit 111 and a digital signage 130 associated with the predetermined position in the store.

When the calculated distance L is equal to or less than the predetermined value (Yes in step S215), the display control unit 112 causes the digital signage 130 to display the advertisement selected in step S212 (step S216).

As described above, according to the present fourth example embodiment, the customer recognition unit 310 of the information processing device 110 recognizes a customer who has come to a store, the purchase history acquisition unit 311 acquires the purchase history information on the recognized customer, and the advertisement selection unit 312 selects an advertisement based on the acquired purchase history information. When the distance between the position of the customer and the position of the digital signage 130 is equal to or less than a predetermined value, the display control unit 112 causes the digital signage 130 to display the advertisement selected based on the purchase history information.

By adopting the above configuration, according to the present fourth example embodiment, an advertisement having contents specialized for the customer can be displayed on the digital signage 130 at an appropriate timing, and it is thus possible to obtain an effect that the appeal effect of the advertisement can be further enhanced.

For example, in a case where a plurality of digital signage 130 is installed in a store and a plurality of customers is detected in the store, an advertisement having contents specialized for each customer can be displayed on the digital signage 130 closest to each customer.

### Fifth Example Embodiment

A fifth example embodiment will be described.

In the fifth example embodiment, an operation in a case where a plurality of customers is detected in the information processing system 300 described in the fourth example embodiment will be described.

In an information processing device 110 of an information processing system according to the fifth example embodiment, the operation of a customer recognition unit 310 is different from the operation in the fourth example embodiment. In the present example embodiment, the operation of the customer recognition unit 310 will be mainly described.

In the fifth example embodiment, the customer recognition unit 310 recognizes a plurality of customers, and additionally specifies a customer to whom an advertisement is to be displayed, when there is a plurality of customers whose distances from a digital signage 130 are equal to or less than a predetermined value.

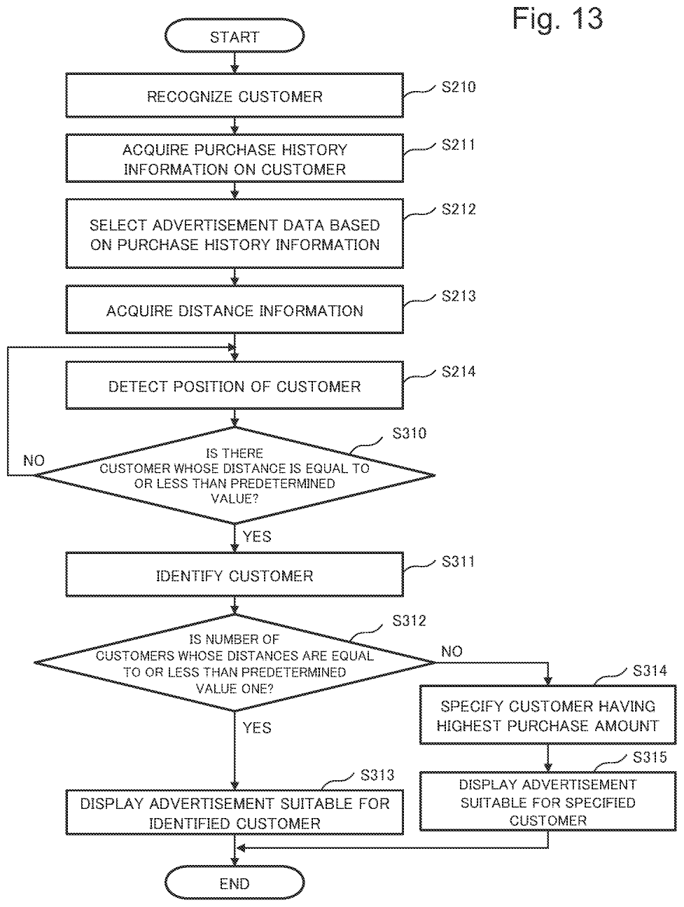

FIG. 13 is a flowchart explaining an operation of the information processing system according to the fifth example embodiment. In FIG. 13, reference signs that match the reference signs given in FIG. 12 denote the same processing.

The customer recognition unit 310 recognizes a plurality of customers who has come to the store (step S210). A purchase history acquisition unit 311 acquires pieces of purchase history information associated with each of the customer IDs of the recognized customers (step S211). Based on each piece of the purchase history information, an advertisement selection unit 312 selects advertisement data suitable for the customer per customer ID (step S212).

A distance measuring device 140 performs distance measurement in response to an instruction from the information processing device 110 (step S213). A detection unit 111 detects the position of each of the plurality of customers (step S214).

In step S310, a display control unit 112 individually calculates the distance L between each position of the plurality of customers detected by the detection unit 111 and the digital signage 130 associated with the predetermined position in the store.

When there is a customer whose distance L from the digital signage 130 is equal to or less than the predetermined value (Yes in step S310), the display control unit 112 instructs the customer recognition unit 310 to identify the customer. The customer recognition unit 310 identifies the customer whose distance L is equal to or less than the predetermined value (step S311). For example, the customer recognition unit 310 may identify the customer by collating the feature amount of the customer contained in the imaged data acquired from an imaging device 160 with the feature amount of the customer recognized by the customer recognition unit 310.

When the number of customers whose distances L from the digital signage 130 are equal to or less than the predetermined value is one (Yes in step S312), the display control unit 112 causes an advertisement selected by the advertisement selection unit 312 to be displayed by regarding the selected advertisement as being suitable for the above-identified customer (S313).

On the other hand, when the number of customers whose distances from the digital signage 130 are equal to or less than the predetermined value is not one (No in step S312), the customer recognition unit 310 specifies a customer having the highest purchase amount, based on the purchase history information associated with each identified customer (step S314). Specifically, the customer recognition unit 310 sums the purchase amounts contained in the purchase history information per identified customer to specify a customer having the highest sum amount obtained above, and notifies the display control unit 112 of the customer ID of the specified customer.

The display control unit 112 displays an advertisement selected by the advertisement selection unit 312 by regarding the selected advertisement as being suitable for the customer with the received customer ID (step S315).

As described above, in the information processing system according to the present fifth example embodiment, in a case where there is a plurality of customers positioned within a predetermined distance from the digital signage 130, the customer recognition unit 310 specifies a customer to whom the advertisement is to be displayed, according to the past purchase amount of the customer. Consequently, according to the present fifth example embodiment, it is possible to obtain an effect that an advertisement can be preferentially displayed to a customer having a high purchase amount.

### Sixth Example Embodiment

A sixth example embodiment will be described.

In the sixth example embodiment, another example of specifying a customer by the customer recognition unit 310 in the information processing system described in the fifth example embodiment will be described.

In the sixth example embodiment, a customer recognition unit 310 has a function of tracking the recognized customer in the store. Specifically, the customer recognition unit 310 may recognize the customer from the imaged data to track the customer between frames, and calculate time-series information on the position of the customer to generate customer tracking information. Existing methods can be used to track the customer. For example, a method based on a Kalman filter, a method based on a particle filter, or the like may be used.

The customer recognition unit 310 performs tracking per customer to generate the customer tracking information, and calculates a moving speed per customer, based on the generated customer tracking information. Existing methods can be used as an approach for calculating the moving speed from the customer tracking information.

Here, it is considered that a customer with a slow moving speed is more likely to view the advertisement than a customer with a fast moving speed. Thus, in the sixth example embodiment, the advertisement is displayed to a customer with a slow moving speed among a plurality of customers.

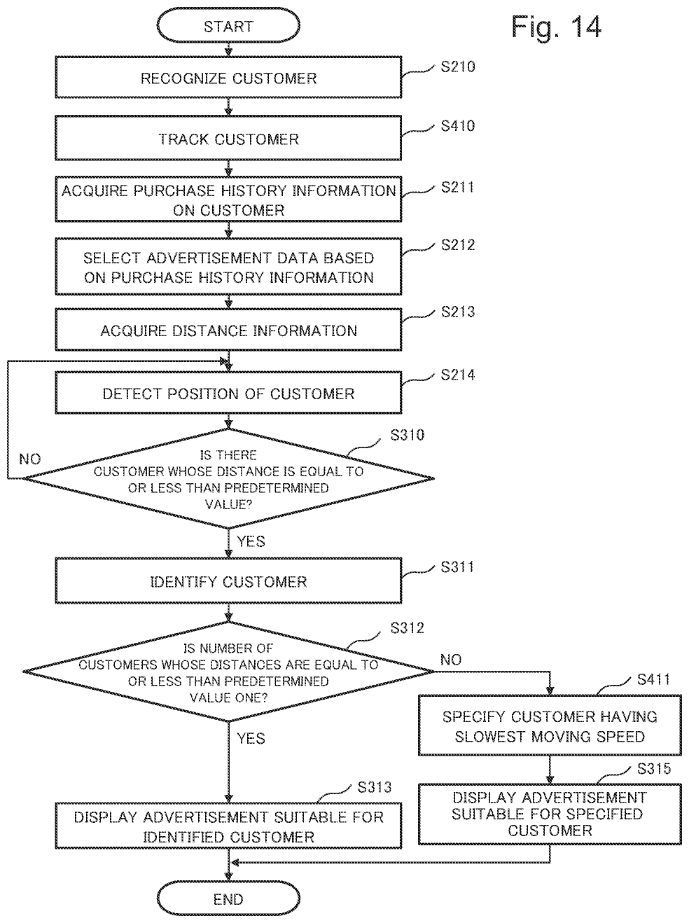

FIG. 14 is a flowchart explaining an operation of an information processing system according to the sixth example embodiment. In FIG. 14, reference signs that match the reference signs given in FIGS. 12 and 13 denote the same processing. In the present example embodiment, an operation different from the operation of the fourth and fifth example embodiments will be mainly described.

The customer recognition unit 310 recognizes a plurality of customers who has come to the store (step S210), and performs tracking per recognized customer (step S410).

A purchase history acquisition unit 311 acquires pieces of purchase history information associated with each of the customer IDs of the recognized customers (step S211). Based on each piece of the purchase history information, an advertisement selection unit 312 selects advertisement data suitable for the customer per customer ID (step S212).

A distance measuring device 140 performs distance measurement in response to an instruction from an information processing device 110 (step S213). A detection unit 111 detects the position of each of the plurality of customers (step S214).

In step S310, a display control unit 112 individually calculates the distance L between each position of the plurality of customers detected by the detection unit 111 and the digital signage 130 associated with the predetermined position in the store.

When there is a customer whose distance L from the digital signage 130 is equal to or less than the predetermined value (Yes in step S310), the display control unit 112 instructs the customer recognition unit 310 to identify the customer. The customer recognition unit 310 identifies the customer whose distance L is equal to or less than the predetermined value (step S311).

When the number of customers whose distances from the digital signage 130 are equal to or less than the predetermined value is not one at the time when the customer whose distance L is equal to or less than the predetermined value is identified in step S311 (No in step S312), the customer recognition unit 310 further calculates the moving speed of each customer being tracked as described above. Then, the customer recognition unit 310 specifies a customer having the slowest moving speed (step S411). The customer recognition unit 310 notifies the display control unit 112 of the specified customer ID.

The display control unit 112 displays an advertisement selected by the advertisement selection unit 312 by regarding the selected advertisement as being suitable for the customer with the received customer ID (step S315).

When the number of customers whose distances L from the digital signage 130 are equal to or less than the predetermined value is one (Yes in step S312), the display control unit 112 causes the advertisement selected by the advertisement selection unit 312 to be displayed by regarding the selected advertisement as being suitable for the identified customer (S313).

As described above, in the information processing system according to the present sixth example embodiment, in a case where there is a plurality of customers positioned within a predetermined distance from the digital signage 130, the customer recognition unit 310 specifies a customer to whom the advertisement is to be displayed, according to the moving speed. Consequently, according to the present sixth example embodiment, by displaying an advertisement suitable for a customer having the lowest moving speed, it is possible to obtain an effect that the advertisement can be preferentially displayed to a customer who is highly likely to view the advertisement.

The result of tracking the customer may be used as follows. That is, an advertisement may be displayed on a digital signage 130 closest to a customer as this customer moves, and the display of the advertisement may be stopped when it is detected by tracking that the customer has arrived at the vicinity of a product shelf of a product displayed in the displayed advertisement.

In the fifth and sixth example embodiments, it has been described that, when a plurality of customers is within a predetermined distance from the digital signage 130, an advertisement suitable for a customer specified based on the purchase amount or the moving speed of the customer is displayed. However, the example embodiments are not limited these example embodiments. For example, advertisements individually suitable for a plurality of customers may be displayed on the digital signage 130 in a predetermined order.

### Seventh Example Embodiment

A seventh example embodiment will be described.

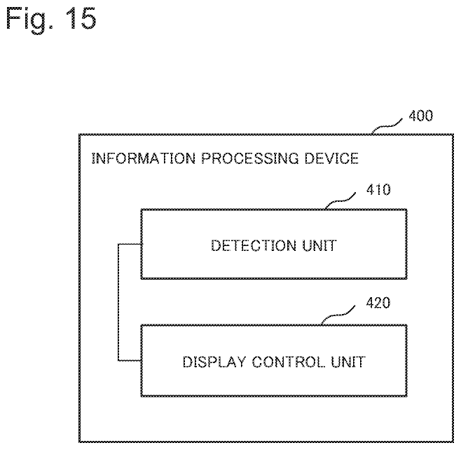

FIG. 15 is a block diagram illustrating a configuration of an information processing device 400 according to the seventh example embodiment. As illustrated in FIG. 15, the information processing device 400 includes a detection unit 410 and a display control unit 420.

The detection unit 410 detects the position of a customer who has come to a store. The display control unit 420 causes a display device associated with a predetermined position in the store to display an advertisement when a distance between the detected position of the customer and the predetermined position is equal to or less than a predetermined value.

By adopting the above configuration, according to the present seventh example embodiment, it is possible to obtain an effect that an advertisement can be outputted at an appropriate timing when a customer has approached the display device within a predetermined distance.

While the present disclosure has been particularly shown and described with reference to example embodiments thereof, the present disclosure is not limited to these example embodiments. For example, the configurations in the above example embodiments can be combined with each other without departing from the scope of the present disclosure.

For example, the determination unit 210 described in the second example embodiment may be included in the information processing devices described in the third to sixth example embodiments. When acquiring the determination result that the face of the customer is facing the digital signage 130 from the determination unit 210, the display control units 112 in the third to sixth example embodiments may cause the digital signage 130 to display an advertisement.

Several modifications are also conceivable in each example embodiment.

For example, the detection unit 111 is not limited to detecting the position of the customer in the store based on the distance information generated by the distance measuring device 140, and may detect the position of the customer based on the imaged data obtained by the imaging device 160. The display control unit 112 may calculate a distance between the position of the customer detected based on the imaged data and the position of the digital signage 130. In this case, the information processing system may have a configuration not including the distance measuring device 140.

Furthermore, the determination unit 210 is not limited to detecting the orientation of the face of the customer 20 based on the distance information obtained by the distance measuring device 140, and may detect the orientation of the face of the customer 20 based on the imaged data acquired from the imaging device 160. That is, the determination unit 210 may examine the imaged data to detect the orientation of the face of the customer, and determine whether the orientation of the face is facing the digital signage 130.

The determination unit 210 is not limited to detecting the orientation of the face of the customer, and may detect the orientation of the line of sight of the customer. In this case, a line-of-sight sensor may be attached to the digital signage 130 in such a way that the orientation of the line of sight of the customer is detected based on the detection result of the line-of-sight sensor. When it is determined that the orientation of the line of sight of the customer is facing the digital signage 130, the display control unit 112 may cause the digital signage 130 to display an advertisement. This enables to make the timing of displaying the advertisement more appropriate.

In each example embodiment, it has been described that the display of the advertisement displayed on the digital signage 130 may be stopped at various sorts of timings, but the example embodiment is not limited to stopping the display. For example, an advertisement having contents specialized for a customer may be switched to an advertisement having general contents.

(Hardware Configuration)

In each of the above-described example embodiments, some or all of the functional components of each device (the information processing device 110 and the like) may be achieved by any combination of a computer 500 and a program.

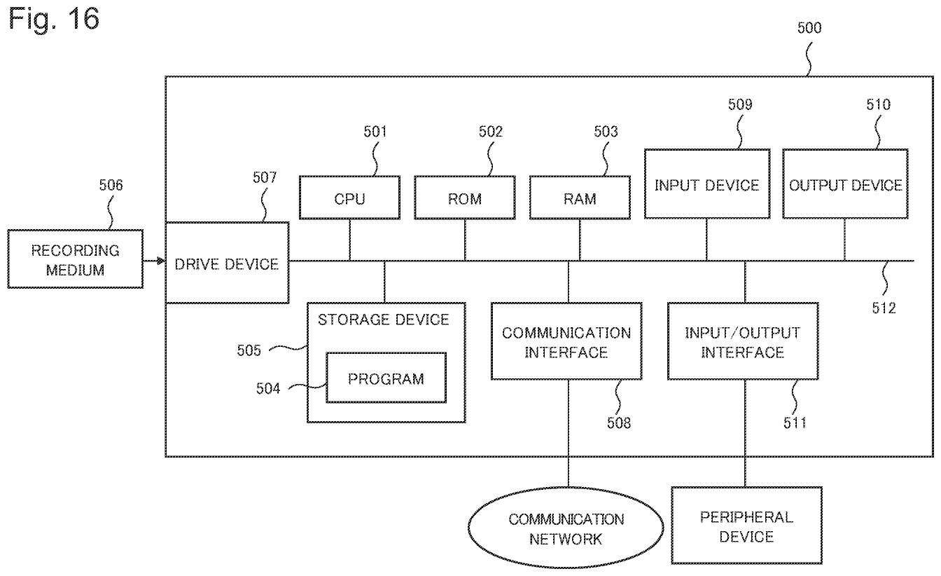

FIG. 16 is a diagram illustrating an example of a hardware configuration of the computer 500. Referring to FIG. 16, the computer 500 includes, for example, a central processing unit (CPU) 501, a read only memory (ROM) 502, a random access memory (RAM) 503, a program 504, a storage device 505, a drive device 507, a communication interface 508, an input device 509, an output device 510, an input/output interface 511, and a bus 512.

The program 504 includes an instruction for achieving each function of each device. The program 504 is stored in advance in the ROM 502, the RAM 503, or the storage device 505. The CPU 501 achieves each function of each device by executing instructions included in the program 504. For example, the CPU 501 of the information processing device 110 executes instructions included in the program 504 to achieve the functions of the detection unit 111, the display control unit 112, the determination unit 210, the customer recognition unit 310, the purchase history acquisition unit 311, and the advertisement selection unit 312. The RAM 503 may store data to be processed in each function of each device. For example, the RAM 503 of the information processing device 110 may store the distance information and the like.

The drive device 507 performs reading and writing on a recording medium 506. The communication interface 508 provides an interface with a communication network. For example, the input device 509 is a mouse, a keyboard, or the like, and receives an input of information from an administrator or the like. The output device 510 is, for example, a display, and outputs (displays) information to an administrator or the like. The input/output interface 511 provides an interface with a peripheral device. The bus 512 connects the constituent elements of the hardware with each other. The program 504 may be supplied to the CPU 501 via the communication network, or may be stored in advance in the recording medium 506 and read out by the drive device 507 to be supplied to the CPU 501.

The hardware configuration illustrated in FIG. 13 is an example, and constituent elements other than those illustrated may be added or some constituent elements may not be included.

The method for achieving each device has various modifications. For example, each device may be achieved by any combinations of computers and programs different from each other for each constituent element. A plurality of constituent elements included in each device may be achieved by any one combination of a computer and a program.

Some or all of multiple constituent elements of each device may be achieved by general-purpose or dedicated circuitry including a processor or the like, or a combination of pieces of circuitry. These pieces of circuitry may be constituted by a single chip or a plurality of chips connected via a bus. Some or all of multiple constituent elements of each device may be achieved by a combination of the circuitry or the like described above and a program.

In a case where some or all of multiple constituent elements of each device are achieved by a plurality of computers, pieces of circuitry, or the like, the plurality of computers, pieces of circuitry, or the like may be centrally arranged or dispersedly arranged.

In addition, it will be understood by those of ordinary skill in the art that various changes in form and details may be made therein without departing from the spirit and scope of the present disclosure as defined by the claims. For example, an example embodiment in which a part of the configuration of any example embodiment is added to another example embodiment or an example embodiment in which a part of the configuration of any example embodiment is replaced with a part of the configuration of another example embodiment is also an example embodiment to which the present disclosure can be applied.

Furthermore, in the plurality of flowcharts used in the above description, a plurality of steps (pieces of processing) is described in order, but the execution order of the steps executed in each example embodiment is not restricted to the described order. In each example embodiment, the order of the illustrated steps can be altered as long as there is no interference in terms of contents.

A processing method of causing a recording medium to record a program for operating the configuration of each of the above-described example embodiments in such a way as to achieve the function of each of the example embodiments, reading out the program recorded in the recording medium as a code, and executing the program in a computer is also included in the scope of each of the example embodiments. That is, a computer-readable recording medium is also included in the scope of each example embodiment. Not only a recording medium in which the above-described computer program is recorded, but also the whole recorded computer program is included in each example embodiment.

For example, a floppy (registered trademark) disk, a hard disk, an optical disc, a magneto-optical disk, a compact disc-read only memory (CD-ROM), a magnetic tape, a nonvolatile memory card, and a ROM can be used as the recording medium. The example embodiments are not limited to a case where processing is executed by a single program recorded in the recording medium, and a case where processing is executed on an operating system (OS) in cooperation with the functions of other software and an extension board is also included in the scope of each example embodiment.

Some or all of the above example embodiments can also be described as in the following supplementary notes, but are not limited to the following.

(Supplementary Note 1)

An information processing device including:

a detection means for detecting a position of a customer who has come to a store; and

a display control means for causing a display device associated with a predetermined position in the store to display an advertisement when a distance between the detected position of the customer and the predetermined position is equal to or less than a predetermined value.

(Supplementary Note 2)

The information processing device according to supplementary note 1, further including:

a customer recognition means for recognizing the customer; and

an advertisement selection means for selecting an advertisement based on a purchase history associated with the recognized customer, in which

the display control means causes the display device to display the selected advertisement.

(Supplementary Note 3)

The information processing device according to supplementary note 1 or 2, in which

the display control means causes a display device associated with a position among a plurality of the predetermined positions, at which a distance from the position of the customer is smaller than another display device and the distance is equal to or less than the predetermined value, to display the advertisement.

(Supplementary Note 4)

The information processing device according to supplementary note 2, in which

when the customer recognition means recognizes a plurality of customers,

the advertisement selection means individually selects the advertisement based on the purchase history associated with each of the plurality of customers, and

the display control means causes the display device to display the advertisements selected in association with a plurality of the customers whose distances from the predetermined position in the store are equal to or less than the predetermined value, in a predetermined order.

(Supplementary Note 5)

The information processing device according to supplementary note 2, in which

when the customer recognition means recognizes a plurality of customers,

the advertisement selection means individually selects the advertisement based on the purchase history associated with each of the plurality of customers, and

the display control means causes the display device to display the advertisement selected in association with a customer having a higher purchase amount based on the purchase history than another customer, among a plurality of customers whose distances from the predetermined position in the store are equal to or less than the predetermined value.

(Supplementary Note 6)

The information processing device according to supplementary note 2, in which

when the customer recognition means recognizes a plurality of customers,

the advertisement selection means individually selects the advertisement based on the purchase history associated with each of the plurality of customers, and

the display control means causes the display device to display the advertisement selected in association with a customer having a slower moving speed than another customer, among a plurality of customers whose distances from the predetermined position in the store are equal to or less than the predetermined value.

(Supplementary Note 7)

The information processing device according to any one of supplementary notes 1 to 6, further including

a determination means for determining whether an orientation of a face of the customer is facing the display device, in which

the display control means causes the display device to display the advertisement when it is determined that an orientation of a face of a customer at a position at which a distance from the predetermined position in the store is equal to or less than the predetermined value is facing the display device.

(Supplementary Note 8)

The information processing device according to supplementary note 7, in which

when it is determined that the orientation of the face of the customer is not facing the display device, the display control means stops display of the advertisement displayed on the display device.

(Supplementary Note 9)

The information processing device according to any one of supplementary notes 1to 8, in which

the detection means detects the position of the customer based on distance information acquired by a distance measuring device that acquires a distance to a distance measurement target.

(Supplementary Note 10)

An information processing system including:

the information processing device according to any one of supplementary notes 1 to 9; and

a display device installed in association with a predetermined position in the store.

(Supplementary Note 11)

A display control method including:

detecting a position of a customer who has come to a store; and

causing a display device associated with a predetermined position in the store to display an advertisement when a distance between the detected position of the customer and the predetermined position is equal to or less than a predetermined value.

(Supplementary Note 12)

The display control method according to supplementary note 11, including:

recognizing the customer;

selecting an advertisement based on a purchase history associated with the recognized customer; and

causing the display device to display the selected advertisement.

(Supplementary Note 13)

The display control method according to supplementary note 11 or 12, including

causing a display device associated with a position among a plurality of the predetermined positions, at which a distance from the position of the customer is smaller than another display device and the distance is equal to or less than the predetermined value, to display the advertisement.

(Supplementary Note 14)

The display control method according to supplementary note 12, including:

when a plurality of customers is recognized,

individually selecting the advertisement based on the purchase history associated with each of the plurality of customers; and

causing the display device to display the advertisements selected in association with a plurality of the customers whose distances from the predetermined position in the store are equal to or less than the predetermined value, in a predetermined order.

(Supplementary Note 15)

The display control method according to supplementary note 12, including:

when a plurality of customers is recognized,

individually selecting the advertisement based on the purchase history associated with each of the plurality of customers; and

causing the display device to display the advertisement selected in association with a customer having a higher purchase amount based on the purchase history than another customer, among a plurality of customers whose distances from the predetermined position in the store are equal to or less than the predetermined value.

(Supplementary Note 16)

The display control method according to supplementary note 12, including:

when a plurality of customers is recognized,

individually selecting the advertisement based on the purchase history associated with each of the plurality of customers; and

causing the display device to display the advertisement selected in association with a customer having a slower moving speed than another customer, among a plurality of customers whose distances from the predetermined position in the store are equal to or less than the predetermined value.

(Supplementary Note 17)

The display control method according to any one of supplementary notes 11 to 16, including:

determining whether an orientation of a face of the customer is facing the display device; and

causing the display device to display the advertisement when it is determined that an orientation of a face of a customer at a position at which a distance from the predetermined position in the store is equal to or less than the predetermined value is facing the display device.

(Supplementary Note 18)

The display control method according to supplementary note 17, including

stopping display of the advertisement displayed on the display device when it is determined that the orientation of the face of the customer is not facing the display device.

(Supplementary Note 19)

The display control method according to any one of supplementary notes 11 to 18, including

detecting the position of the customer based on distance information acquired by a distance measuring device that acquires a distance to a distance measurement target.

(Supplementary Note 20)

A computer-readable recording medium recording a program for causing a computer to execute:

processing of detecting a position of a customer who has come to a store; and

processing of causing a display device associated with a predetermined position in the store to display an advertisement when a distance between the detected position of the customer and the predetermined position is equal to or less than a predetermined value.

The present invention has been described above with reference to the above-described example embodiments as typical examples. However, the present invention is not limited to the example embodiments described above. That is, the present invention can apply various aspects that can be understood by those of ordinary skill in the art, within the scope of the present invention.

This application is based upon and claims the benefit of priority from Japanese patent application No. 2019-53722, filed on Mar. 20, 2019, the disclosure of which is incorporated herein in its entirety by reference.

### REFERENCE SIGNS LIST

100 information processing system
110 information processing device
111 detection unit
112 display control unit
113 storage unit
120 POS device
130 digital signage
140 distance measuring device
150 storage device

What is claimed is:

1. An information processing device comprising:
at least one memory storing instructions; and
at least one processor configured to access the at least one memory and execute the instructions to:
detect a position of a customer who has come to a store; and
cause a display device associated with a predetermined position in the store to display an advertisement when a distance between the detected position of the customer and the predetermined position is equal to or less than a predetermined value.

2. The information processing device according to claim 1, wherein
the at least one processor is further configured to execute the instructions to:
recognize the customer;
select an advertisement based on a purchase history associated with the recognized customer; and
cause the display device to display the selected advertisement.

3. The information processing device according to claim 1, wherein
the at least one processor is further configured to execute the instructions to:
cause a display device associated with a position among a plurality of the predetermined positions, at which a distance from the position of the customer is smaller than another display device and the distance is equal to or less than the predetermined value, to display the advertisement.

4. The information processing device according to claim 2, wherein
the at least one processor is further configured to execute the instructions to:
when a plurality of customers are recognized,
select the advertisement based on the purchase history associated with each of the plurality of customers; and
cause the display device to display the advertisements selected in association with a plurality of the customers whose distances from the predetermined position in the store are equal to or less than the predetermined value, in a predetermined order.

5. The information processing device according to claim 2, wherein
the at least one processor is further configured to execute the instructions to:
when a plurality of customers are recognized,
select the advertisement based on the purchase history associated with each of the plurality of customers; and
cause the display device to display the advertisement selected in association with a customer having a higher purchase amount based on the purchase history than another customer, among a plurality of customers whose distances from the predetermined position in the store are equal to or less than the predetermined value.

6. The information processing device according to claim 2, wherein
the at least one processor is further configured to execute the instructions to:
when a plurality of customers are recognized,
select the advertisement based on the purchase history associated with each of the plurality of customers; and
cause the display device to display the advertisement selected in association with a customer having a slower moving speed than another customer, among a plurality of customers whose distances from the predetermined position in the store are equal to or less than the predetermined value.

7. The information processing device according to claim 1, further
the at least one processor is further configured to execute the instructions to:
determine whether an orientation of a face of the customer is facing the display device;
cause the display device to display the advertisement when it is determined that an orientation of a face of a customer at a position at which a distance from the predetermined position in the store is equal to or less than the predetermined value is facing the display device.

8. The information processing device according to claim 7, wherein
the at least one processor is further configured to execute the instructions to:
when it is determined that the orientation of the face of the customer is not facing the display device, stop display of the advertisement displayed on the display device.

9. The information processing device according to claim 1, wherein
the at least one processor is further configured to execute the instructions to:
detect the position of the customer based on distance information acquired by a distance measuring device that acquires a distance to a distance measurement target.

10. An information processing system comprising:
the information processing device according to claim 1; and
a display device installed in association with a predetermined position in the store.

11. A display control method comprising:
detecting a position of a customer who has come to a store; and
causing a display device associated with a predetermined position in the store to display an advertisement when a distance between the detected position of the customer and the predetermined position is equal to or less than a predetermined value.

12. The display control method according to claim 11, comprising:
recognizing the customer;
selecting an advertisement based on a purchase history associated with the recognized customer; and
causing the display device to display the selected advertisement.

13. The display control method according to claim 11, comprising
causing a display device associated with a position among a plurality of the predetermined positions, at which a distance from the position of the customer is smaller than another display device and the distance is equal to or less than the predetermined value, to display the advertisement.

14. The display control method according to claim 12, comprising:
when a plurality of customers is recognized,
individually selecting the advertisement based on the purchase history associated with each of the plurality of customers; and
causing the display device to display the advertisements selected in association with a plurality of the customers whose distances from the predetermined position in the store are equal to or less than the predetermined value, in a predetermined order.

15. The display control method according to claim 12, comprising:
when a plurality of customers is recognized,
individually selecting the advertisement based on the purchase history associated with each of the plurality of customers; and
causing the display device to display the advertisement selected in association with a customer having a higher purchase amount based on the purchase history than another customer, among a plurality of customers whose distances from the predetermined position in the store are equal to or less than the predetermined value.

16. The display control method according to claim 12, comprising:
when a plurality of customers is recognized,
individually selecting the advertisement based on the purchase history associated with each of the plurality of customers; and
causing the display device to display the advertisement selected in association with a customer having a slower moving speed than another customer, among a plurality of customers whose distances from the predetermined position in the store are equal to or less than the predetermined value.

17. The display control method according to claim 11, comprising:
determining whether an orientation of a face of the customer is facing the display device; and
causing the display device to display the advertisement when it is determined that an orientation of a face of a customer at a position at which a distance from the predetermined position in the store is equal to or less than the predetermined value is facing the display device.

18. The display control method according to claim 17, comprising
stopping display of the advertisement displayed on the display device when it is determined that the orientation of the face of the customer is not facing the display device.

19. The display control method according to claim 11, comprising
detecting the position of the customer based on distance information acquired by a distance measuring device that acquires a distance to a distance measurement target.

20. A non-transitory computer-readable recording medium recording a program for causing a computer to execute:
processing of detecting a position of a customer who has come to a store; and
processing of causing a display device associated with a predetermined position in the store to display an advertisement when a distance between the detected position of the customer and the predetermined position is equal to or less than a predetermined value.
